(19) United States
(12) Patent Application Publication
(10) Pub. No.: US 2005/0058519 A1
(43) Pub. Date: Mar. 17, 2005

(54) Positioning device

(76) Inventor: Chih-Kang Chang, Taipei (TW)

Correspondence Address: HARNESS, DICKEY & PIERCE, P.L.C., P.O. BOX 8910, RESTON, VA, 20195, US

(21) Appl. No.: 10/910,609

(22) Filed: Aug. 4, 2004

(30) Foreign Application Priority Data
Sep. 15, 2003 (TW) 092216565

(51) Int. Cl. B60P 3/06

(52) U.S. Cl. 410/7

(57) ABSTRACT

A positioning device is provided. The positioning device for positioning a carrier in a vehicle includes a first positioning structure and a second positioning structure. The first positioning structure is disposed on the carrier, and the carrier carries at least one wafer box. The second positioning structure is disposed on the vehicle and has at least one connecting horizontal shaft for connecting the first positioning structure on the vehicle so as to secure the carrier in the vehicle.

### FIELD OF THE INVENTION

The present invention relates to a positioning device, and more particularly to a positioning device for positioning a carrier in an inner part of a vehicle.

### BACKGROUND OF THE INVENTION

In general, the 12-inch front opening wafer boxes include the front opening shipping box (FOSB), which is for the outdoor transportation usage. During the transportation, the front-opening shipping boxes (FOSB) are carried on a cart. The cart is further fastened in the vehicle with rubbers or belts, and the way of using the rubbers or the belts is quit humble and rough. When we unload these FOSB, it takes a lot of efforts to loose the rubbers or the belts. It is somehow bothersome and inconvenient to the transporter. Therefore, the way of using the rubbers or the belts to fasten the cart is not convenient.

Therefore, how to fasten and stabilize a carrier in a vehicle has become major problems waited to be solved in the industry. In order to overcome the drawbacks in the prior art, a positioning device is provided. In the particular invention, the problem of humble and rough transportation is solved and it is convenient and fast to position a carrier in a vehicle.

### SUMMARY OF THE INVENTION

The main object of the present invention is to provide a positioning device for positioning a carrier in a vehicle. The positioning device includes a first positioning structure disposed on the carrier, wherein the carrier carries at least one wafer box, and a second positioning structure disposed on the vehicle and having at least one connecting horizontal shaft for connecting the first positioning structure on the vehicle so as to secure the carrier in the vehicle.

Preferably, the second positioning structure has a cushion spring so as to provide the carrier with a cushion effect.

Preferably, the wafer box is a front opening shipping box (FOSB), and the second positioning structure further includes a first and a second connecting component for connecting a first and a second fixing portions of the first positioning structure.

Preferably, the at least one connecting horizontal shaft includes a first and a second connecting horizontal shafts of the first and the second connecting components for being connected to concaves of the first and the second fixing portions.

Preferably, the first and the second connecting components further include a first and a second rotating axles for rotating the first and the second connecting horizontal shafts, and a first and a second braking sections are used for controlling rotations of the first and the second rotating axles.

Preferably, the first connecting component has a propping shaft for propping the first connecting component, and the propping shaft has a bending pivot for bending the propping shaft.

Preferably, the first connecting component has a placing shaft for placing the first connecting component in a fillister.

Preferably, the second connecting component is disposed on a base plate and has a movable shaft and a fast clamp, and the movable shaft is pushed forward along a slipping slot of the base plate by the fast clamp.

Preferably, the movable shaft is pushed a horizontal distance for securing the second connecting component to the second fixing portion.

Preferably, the second positioning structure has a first and a second plates for covering the first and the second connecting horizontal shafts, and the second positioning structure has a third plate for covering the fast clamp.

Preferably, the second positioning structure is disposed at a bottom side of the vehicle, and the second connecting component is placed flat at the bottom side of the vehicle by a prop stand.

Preferably, the carrier is a hand-operated cart, and the vehicle is a truck.

Preferably, a heat-dissipating hole is disposed in the vehicle for dissipating heat in an inner part of the vehicle.

Preferably, a monitor is set in the vehicle for monitoring a transporting process.

Preferably, a temperature and humidity sensor is set in the vehicle for detecting a temperature and a humidity in the inner part of the vehicle.

Preferably, a charge coupled device (CCD) monitor is set in the vehicle for monitoring a transporting condition of the carrier in the inner part of the vehicle.

It is another object of the present invention to provide a positioning device for positioning a carrier in a vehicle. The positioning device includes a first positioning structure disposed on the carrier, wherein the carrier carries at least one wafer box, and a second positioning structure disposed on the vehicle for connecting the first positioning structure on the vehicle so as to secure the carrier in the vehicle.

Preferably, at least one connecting horizontal shaft is used for connecting the second positioning structure to the first positioning structure.

In accordance with another aspect of the present invention, a positioning device for positioning a carrier in a vehicle is provided. The deposition device includes a first positioning structure disposed on the carrier, and a second positioning structure disposed on the vehicle having at least one connecting horizontal shaft for connecting the first positioning structure on the vehicle so as to secure the carrier in the vehicle.

Preferably, the carrier carries at least one wafer box.

The foregoing and other features and advantages of the present invention will be more clearly understood through the following descriptions with reference to the drawings, in which:

### BRIEF DESCRIPTION OF THE DRAWINGS

FIG. 1 is a schematic view showing positioning device according to a preferred embodiment of the present invention;

FIG. 2(a) is a schematic view showing the first positioning structure of the positioning device according to the preferred embodiment of the present invention;

FIG. 2(b) is a schematic view showing the second positioning structure of the positioning device according to the preferred embodiment of the present invention;

FIG. 3 is a schematic view showing the truck according to a preferred embodiment of the present invention;

FIG. 4 is a detailed schematic view of the second positioning structure in FIG. 2(b);

FIG. 5(a) is a side view showing the first connecting component in FIG. 4;

FIG. 5(b) is a schematic view showing the second connecting component in FIG. 4; and

FIG. 6 is a schematic view showing a placing shaft of the first connecting component in FIG. 4.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only; it is not intended to be exhaustive or to be limited to the precise form disclosed.

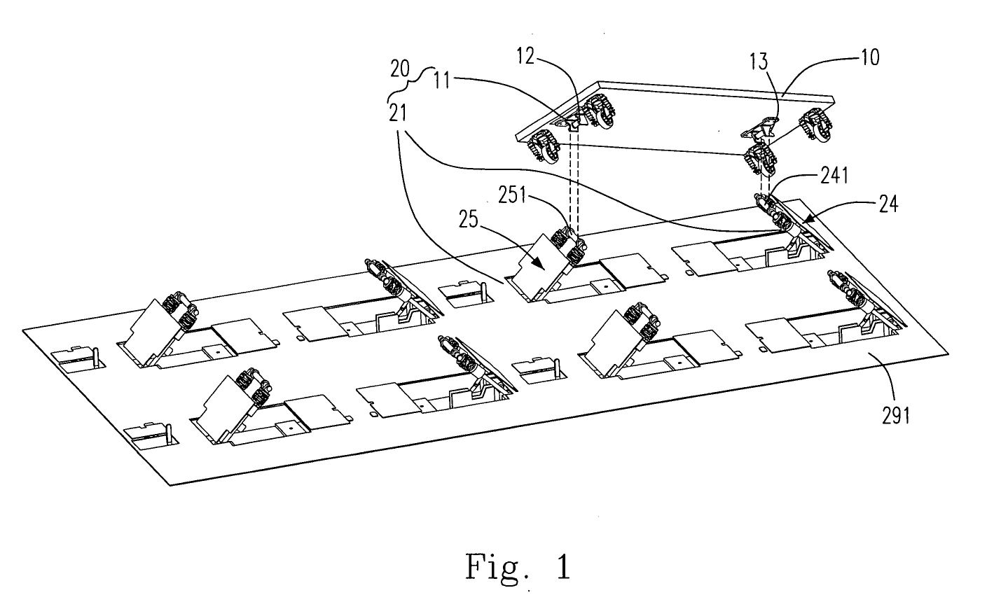

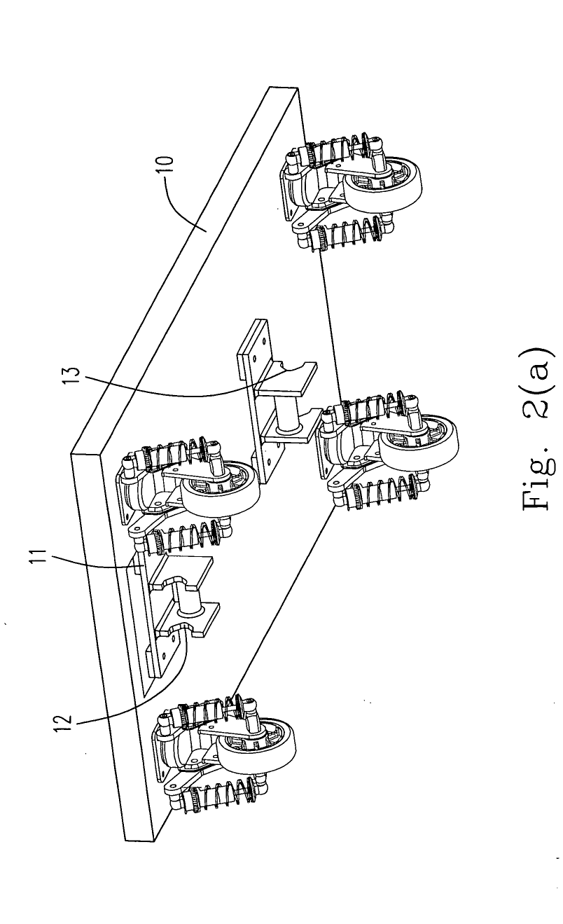

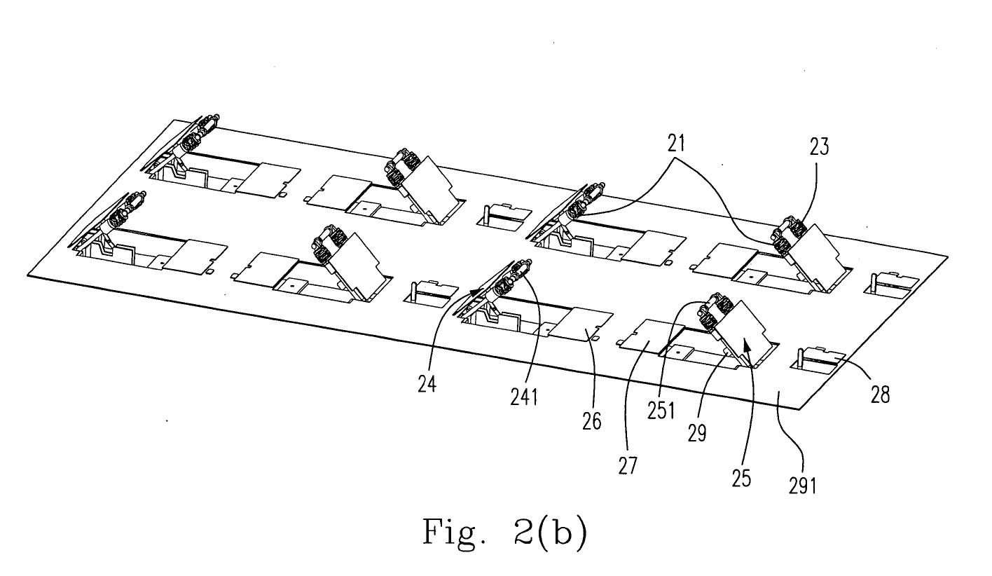

Please refer to FIG. 1. The positioning device 20 includes the first positioning structure 11 and the second positioning structure 21. The first positioning structure 11 has the first fixing portion 12 and the second fixing portion 13, and is disposed on the carrier 10. The carrier 10 is applied to carry at least one wafer box (not shown). A more clear view of the first positioning structure 11 is shown in FIG. 2(a). In addition, the wafer box is a front opening shipping box, the carrier 10 can be a hand-operated cart, and the first fixing portion 12 and the second fixing portion 13 have the concaves. The second positioning structure 21 is able to be disposed in the vehicle ( not shown), and includes the first connecting component 24 with the first connecting horizontal shaft 241 and the second connecting component 25 with the second connecting horizontal shaft 251. Respectively, the first connecting horizontal shaft 241 and the second connecting horizontal shaft 251 are connected to the concaves of the first fixing portion 12 and the second fixing portion 13. The connecting horizontal shafts 241 and 251 are applied to connect the first positioning structure 11 with the vehicle 30 so as to secure the carrier 10 at the bottom side 291 of the vehicle.

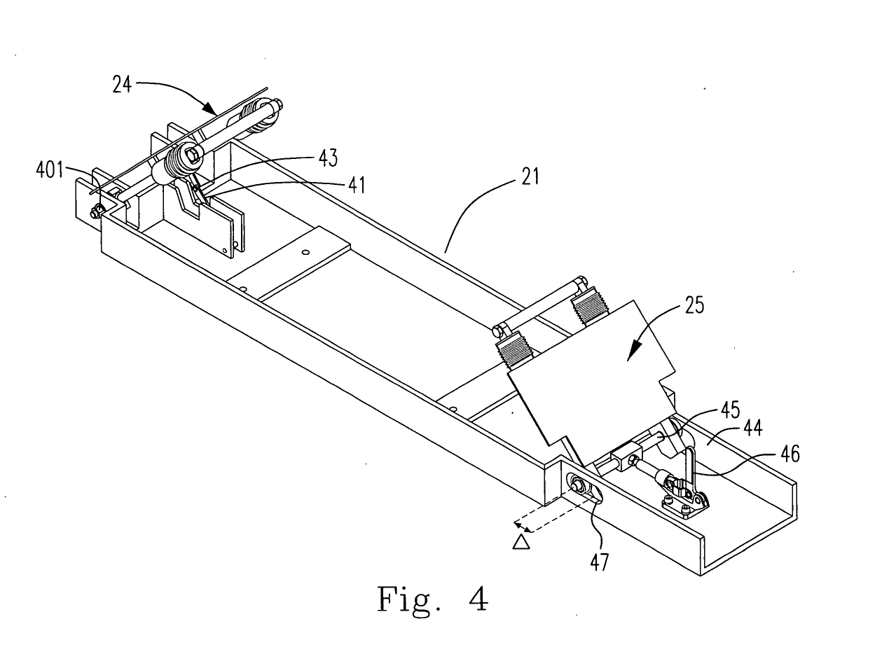

Please refer to FIG. 2(b), which is a schematic view showing the second positioning structure. The second positioning structure 21 further includes the cushion springs 23, the first plate 26, the second plate 27, and the third plate 28. The cushion springs 23 provide a cushion effect for the carrier 10 (shown in FIG. 2(a)). The first connecting horizontal shaft 241, the second connecting horizontal shaft 251, and the fast clamp 46 (shown in FIG. 4) are covered with the first plate 26, the second plate 27, and the third plate 28 respectively. Moreover, the second positioning structure 21 is disposed at the bottom side 291 of the vehicle, i.e. the second connecting component 25 of the second positioning structure 21 is placed flat at the bottom side 291 of the vehicle by the prop stand 29.

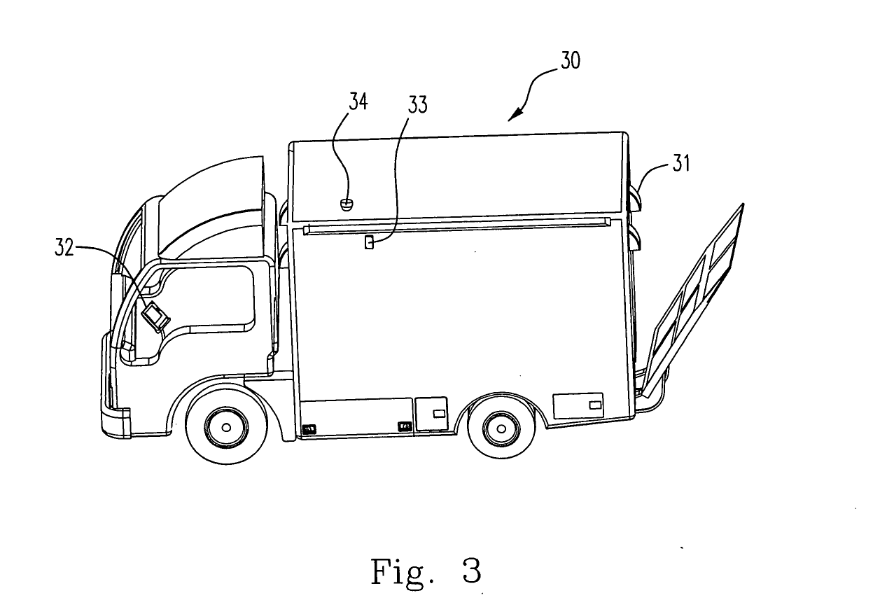

Please refer to FIG. 3. The vehicle 30 is a truck. The vehicle 30 has the heat-dissipating hole 31, the monitor 32, the temperature and humidity sensor 33, and the charged coupled device monitor (CCD) 34. The heat-dissipating hole 31 is applied to dissipate heat in the inner part of the vehicle 30; the monitor 32 is applied to monitor the transporting process, the temperature and humidity sensor 33 is set to detect the temperature and humidity in the inner part of the vehicle 30, the charged coupled device monitor (CCD) 34 is set to monitor the transporting condition of the inner part of the vehicle 30.

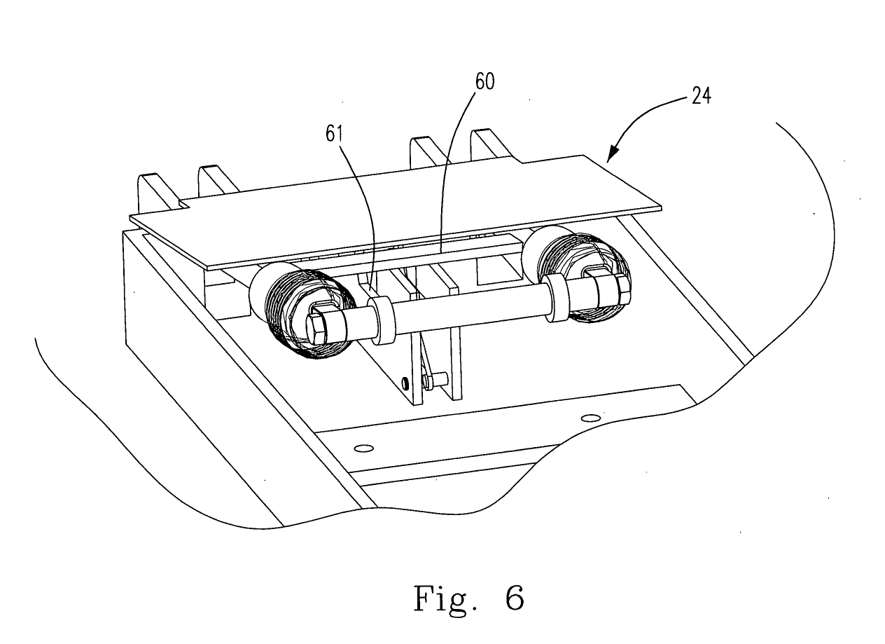

Please refer to FIG. 4, which is a detailed schematic view of FIG. 2(b). The first connecting component 24 of the second positioning structure 21 has the propping shaft 41 for propping the first connecting component 24. The propping shaft 41 has the bending pivot 43 for bending itself. Please also refer to FIG. 6. The first connecting component 24 has a placing shaft 60 for placing itself in a fillister 61. In addition, the second connecting component 25 is disposed on the base plate 44 and includes the movable shaft 45 and the fast clamp 46. The movable shaft 45 is pushed forward along the slipping slot 47 of the base plate 44 by the fast clamp 46. The horizontal distance Δ is clearly shown in FIG. 4.

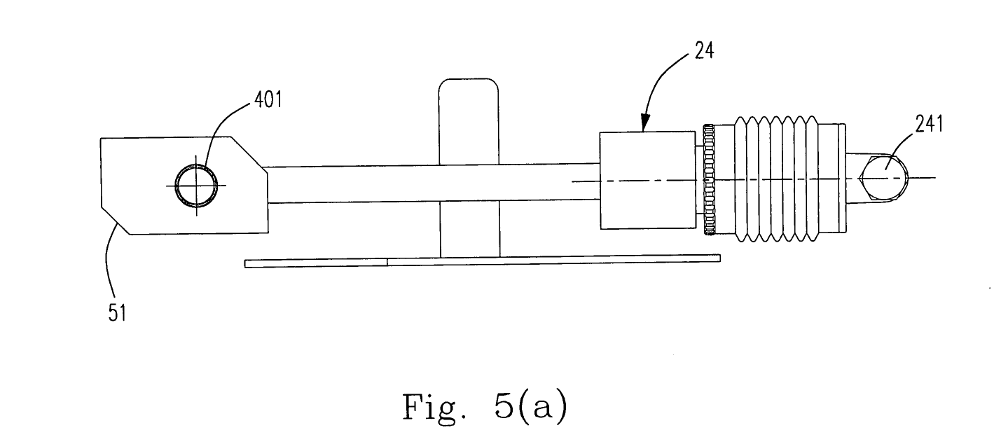

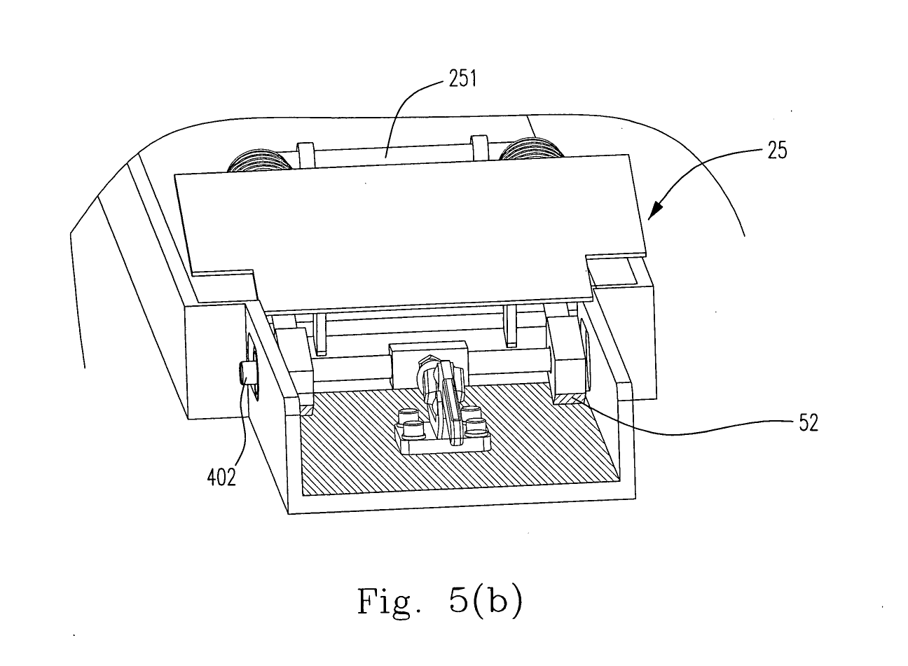

Please refer to FIGS. 5(a) and 5(b), which are side views respectively showing the first connecting component 24 and the second connecting component 25 of FIG. 4. The first connecting component 24 and the second connecting component 25 respectively have the first rotating axle 401 and the second rotating axle 402 for rotating the first and the second connecting horizontal shafts 241 and 251. Further, the first and the second braking seconds 51, 52 are used for controlling the rotations of the first and the second connecting horizontal shafts 241 and 251. Under such a control, the rotation angle is under 45°.

To sum up, the present invention provides a new device to fasten and stabilize a carrier in a vehicle. The original humble and rough way of using the rubbers or the belts is replaced, and the carrier can be easily fastened in the vehicle. Therefore, it is convenient to employ the positioning device for the industry.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims, which are to be accorded with the broadest interpretation so as to encompass all such modifications and similar structures.

1. A positioning device for positioning a carrier in a vehicle, comprising:
a first positioning structure disposed on said carrier, wherein said carrier carries at least one wafer box; and
a second positioning structure disposed on said vehicle and having at least one connecting horizontal shaft for connecting said first positioning structure on said vehicle so as to secure said carrier on said vehicle.

2. The device according to claim 1, wherein said second positioning structure has a cushion spring so as to provide said carrier with a cushion effect.

3. The device according to claim 1, wherein said wafer box is a front opening shipping box (FOSB), and said second positioning structure further comprises a first and a second connecting component for connecting a first and a second fixing portions of said first positioning structure.

4. The device according to claim 3, wherein said at least one connecting horizontal shaft comprises a first and a second connecting horizontal shafts of said first and said second connecting components for being connected to concaves of said first and said second fixing portions.

5. The device according to claim 4, wherein said first and said second connecting components further comprise a first and a second rotating axles for rotating said first and said second connecting horizontal shafts, and a first and a second braking sections are used for controlling rotations of said first and said second rotating axles.

6. The device according to claim 5, wherein said first connecting component has a propping shaft for propping said first connecting component, and said propping shaft has a bending pivot for bending said propping shaft.

7. The device according to claim 6, wherein said first connecting component has a placing shaft for placing said first connecting component in a fillister.

8. The device according to claim 4, wherein said second connecting component is disposed on a base plate, and said second connecting component has a movable shaft and a fast clamp, and said movable shaft is pushed forward by said fast clamp along a slipping slot of said base plate.

9. The device according to claim 8, wherein said movable shaft is pushed a horizontal distance for securing said second connecting component to said second fixing portion.

10. The device according to claim 8, wherein said second positioning structure has a first and a second plates for covering said first and said second connecting horizontal shafts, and said second positioning structure has a third plate for covering said fast clamp.

11. The device according to claim 4, wherein said second positioning structure is disposed at a bottom side of said vehicle, and said second connecting component is placed flat at said bottom side of said vehicle by a prop stand.

12. The device according to claim 1, wherein said carrier is a hand-operated cart, and said vehicle is a truck.

13. The device according to claim 1, wherein a heat-dissipating hole is disposed in said vehicle for dissipating heat in an inner part of said vehicle.

14. The device according to claim 1, wherein a monitor is set in said vehicle for monitoring a transporting process.

15. The device according to claim 1, wherein a temperature and humidity sensor is set in said vehicle for detecting a temperature and a humidity in said inner part of said vehicle.

16. The device according to claim 1, wherein a charge coupled device (CCD) monitor is set in said vehicle for monitoring a transporting condition of said carrier in said inner part of said vehicle.

17. A positioning device for positioning a carrier in a vehicle, comprising:
a first positioning structure disposed on said carrier, wherein said carrier carries at least one wafer box; and
a second positioning structure disposed on said vehicle for connecting said first positioning structure on said vehicle so as to secure said carrier on said vehicle.

18. The device according to claim 17, wherein at least one connecting horizontal shaft is used for connecting said second positioning structure to said first positioning structure.

19. A positioning device for positioning a carrier in a vehicle, comprising:
a first positioning structure disposed on said carrier; and
a second positioning structure disposed on said vehicle having at least one connecting horizontal shaft for connecting said first positioning structure on said vehicle so as to secure said carrier on said vehicle.

20. The device according to claim 19, wherein said carrier carries at least one wafer box.
